(19) United States
(12) Patent Application Publication
(10) Pub. No.: US 2012/0286513 A1
(43) Pub. Date: Nov. 15, 2012

(54) Wind powered vehicle turbine

(76) Inventor: Andrew Carmen Marano, Fairchance, PA (US)

(21) Appl. No.: 13/200,309

(22) Filed: Sep. 23, 2011

(51) Int. Cl. F03D 9/02; F03D 9/00; H02K 53/00

(52) U.S. Cl. 290/50; 290/55; 903/904; 74/DIG. 9

(57) ABSTRACT

This device pertains to the mechanical field used in the engineering of hybrid vehicles. It is new to the art by means of powering a car or hybrid vehicle by the use of wind power. No one has as of yet come up with a way to power a vehicle with the use of wind, this invention will break grounds on inventing hybrid cars using all types of wind turbine technology. It would increase the efficiency of electric powered engines as to decrease the ‘plug-in’ time of electric cars. It will provide another way to power a car without using any liquid fuel source, and using a renewable energy source.

### BACKGROUND OF THE INVENTION

This feat of engineering is made possible by the modern understanding of wind technology. This invention is certified as a device to electrically power a motor vehicle by means of wind turbine technology. This device will be able to power an electric vehicle engine. Some engines are made to be completely electric, but there is a major flaw with these: they need to be plugged in for a while to charge a battery that powers the electric engine. This invention basically cuts the electric charging cord. As gas costs money to power cars, the electric cars use electricity to power the public's cars, which costs money as well. The electric cars that are being made presently must be plugged in sometime, and it takes a while for these types of cars to charge. My invention makes it much simpler to power an electric vehicle. It uses the same turbine technology as windmills charge and power generators. The wind gets sucked in through the grill as the vehicle moves which turns the turbine blade. The turning of the blade provides electricity to charge and power the battery as the car is running and driving on the roadway. The speed of the car will determine how much power the device generates and stores to power the electric engine.

### SUMMARY OF THE INVENTION

The general idea of this invention is a simple wind powered electric generator. This small device would be placed in the engine compartment right behind the grill of the vehicle to capture the wind that has been brought through the grill. The wind would then turn the blade, powering the generator thus charging the battery. The battery would power the electric engine, thus eliminating the need for the vehicle to be constantly plugged in charging.

### DESCRIPTION OF SEVERAL VIEWS OF DRAWINGS

FIG. 1) This view shows the left side of device. It shows the blade connecting to the internal mechanisms used to make electricity which is connected to the power transferring plug to the battery.

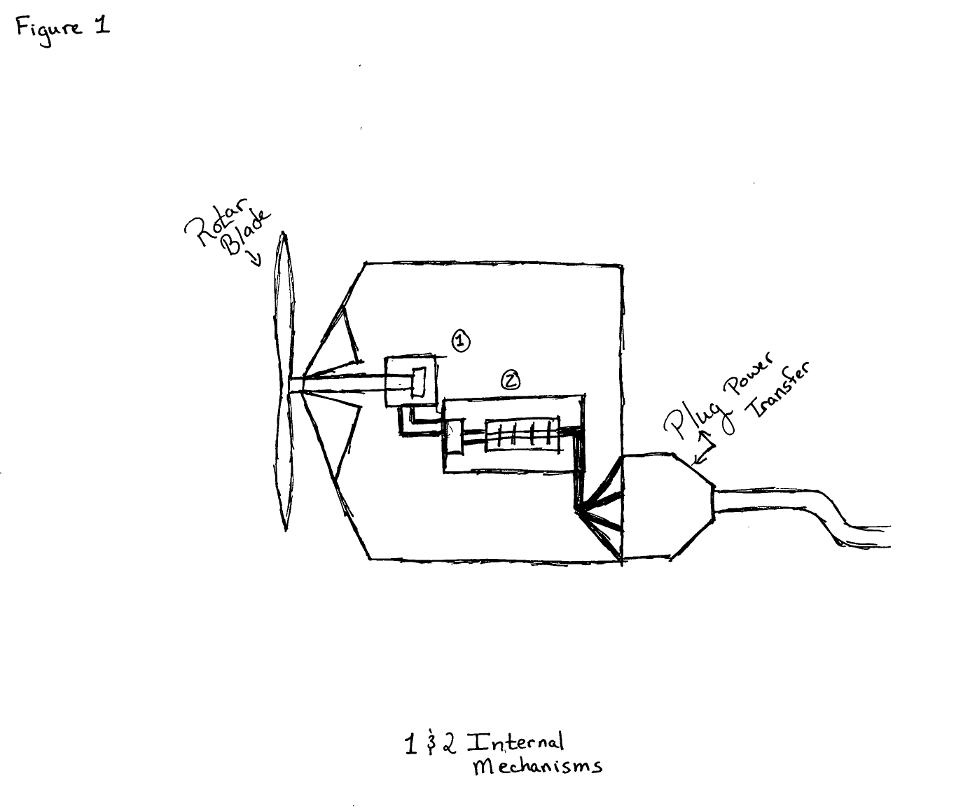

FIG. 2) This view shows the front of the device where the wind will hit, propelling the bladed device to turn thus creating power.

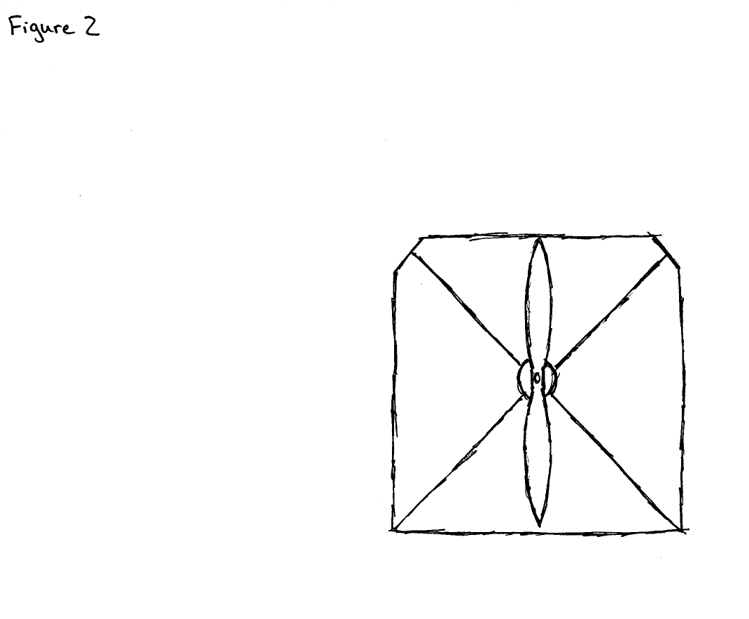

FIG. 3) This view the rear of the device where the plug socket is for the power transferring cord.

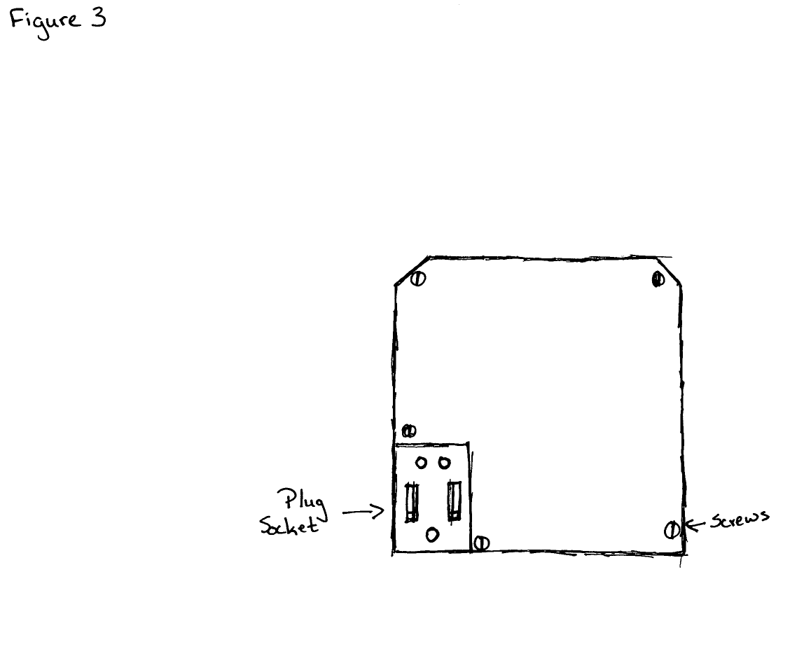

FIG. 4) This drawing depicts an Aston Martin DBS using the device. The wind blowing through the grill of the car turning the blade, transferring the power produced to the battery via cables.

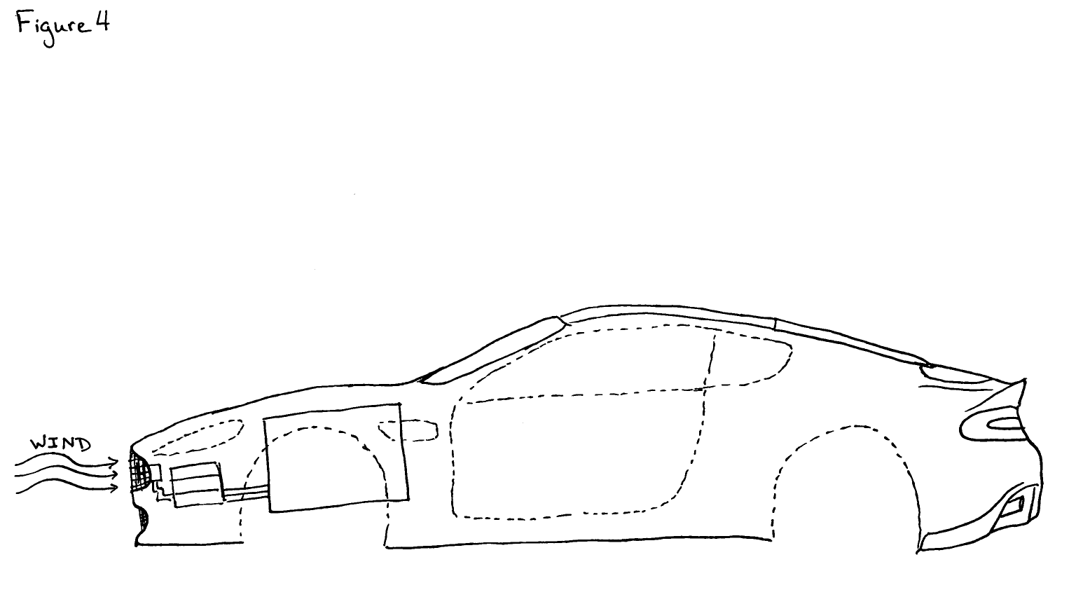

FIG. 5) This drawing uses a Mercedes-Benz S-Class using the device with the wind coming through the grill, thus turning the blade making power.

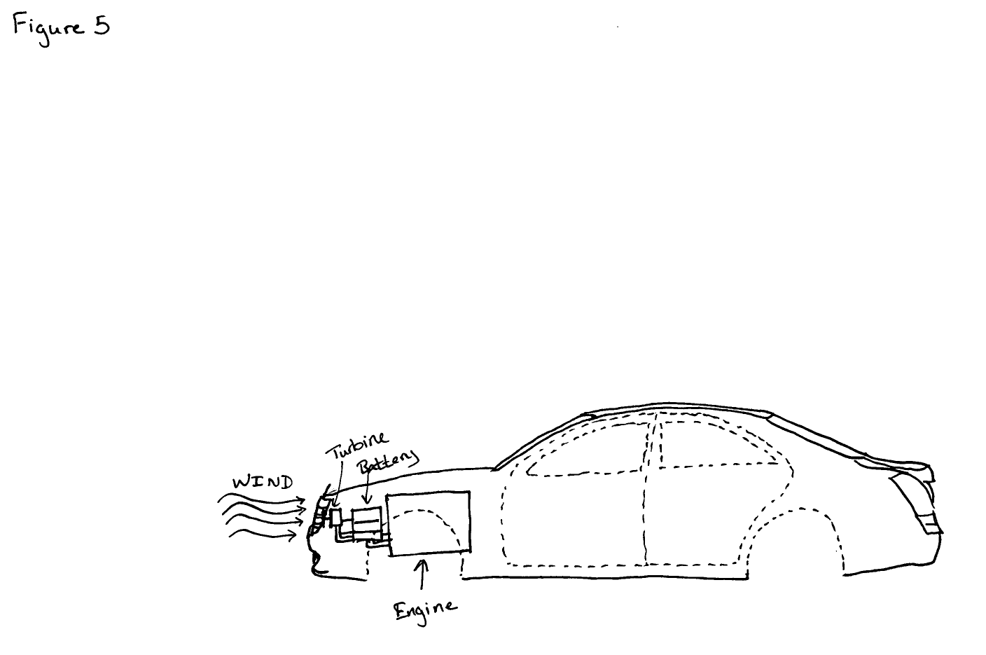

FIG. 6) This drawing depicts a Lamborghini Gallardo using the invention. It shows the wind coming through the low grill powering the bladed device. It gives insight that even sports cars can use this device and still obtain the sports performance.

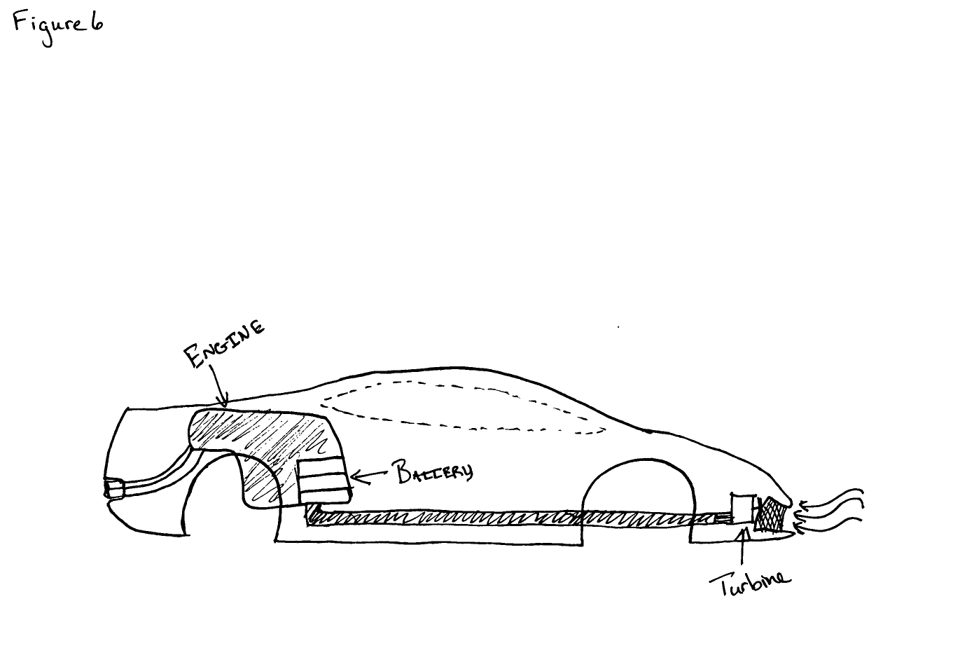

### DESCRIPTION OF THE PREFERRED EMBODIMENT

The preferred embodiment is as a device to electrically power a motor vehicle by means of wind turbine technology. This machine will generate power to a battery. This battery will work as the electric engine battery works in the modem plug-in electric vehicles. A vehicle will still need to be plugged-in if a period of time elapses the power storage of the battery, but the turbine device will build up the power in the battery just as plugging in the car will. The apparatus will generate power from the wind coming in through the grill of the vehicle. It will then be transferred to the battery via connection cables where the power will be stored. The battery will then transfer the power created by the wind turbine to the engine as the current electric engines transfer electricity. The turbine will make a surplus of electric energy; so much as the vehicle will not need to be plugged in to charge for a good time period. This machine will have a blade that turns as a windmill turns, generating power in a similar way. It is a clean, environmentally friendly machine. This apparatus will also have an indicator on the dashboard of the vehicle to show actually how much power the turbine is generating. There will also be a button or switch on the dashboard to turn off the blade and lock it in place if inclement weather may damage the device. This new device will have two, three, or four blades. It will be relatively small which will be beneficial to fit it into an engine compartment without changing the placement of objects in the engine compartment. It would be nothing to place two of these in a car to make even more power even though one would be sufficient to generate enough power to accelerate a car. The machine would then be made of metal to be strong and supportive. In performance vehicles, it could be made of a lightweight material such as carbon fiber. This would be beneficial because there would be no use of gas and very limited use of electricity from the home while plugging in the car. Normal modern all electric cars must be plugged in to the wall using house electric, whereas if the wind turbine is used to power cars, it will eliminate the need for in-wall charging. It would simply charge itself, cutting the cost of operation.

1. Hybrid vehicles using any form of wind power comprising of a two, three, or four bladed small turbine device connected to an electricity generating shaft to produce power to a battery used to power electric hybrid engines.

2. Any vehicle using a wind turbine comprising of a two, three, or four bladed small turbine device connected to an electricity generating shaft to produce power a battery to power electric engines.

3. Any device that takes the shape and form of the projected invention comprising of a two, three, or four bladed small turbine device to power electric engines using wind power.

4. Any device using blade wind turbine technology to power an electric vehicle.

5. Indirectly powering an electric engine using a wind turbine device comprising of a bladed device used to catch wind and use said wind to power the electric engine.

6. Powering and charging a battery with attempt at powering and using an electric engine with said charged battery from the intended invention of wind turbine technology.
